(19) United States
(12) Patent Application Publication
(10) Pub. No.: US 2025/0061131 A1
(43) Pub. Date: Feb. 20, 2025

(54) System and Method for Variable Sankey Charting

(71) Applicant: Salesforce, Inc., San Francisco, CA (US)

(72) Inventors: Vandit GARG, Antioch, CA (US); Wenying YANG, San Mateo, CA (US)

(73) Assignee: Salesforce, Inc., San Francisco, CA (US)

(21) Appl. No.: 18/235,690

(22) Filed: Aug. 18, 2023

(51) Int. Cl. G06F 16/26; G06F 16/28; G06T 11/20

(52) U.S. Cl. CPC G06F 16/26; G06F 16/287; G06T 11/206

(57) ABSTRACT

Disclosed herein are system, method, and computer program product embodiments for implementing variable Sankey charting. The system receives a dataset for charting and various charting parameters. Using the information provided, the system identifies starting and ending categories that will be illustrated in the chart. For each of these categories, the system then calculates a starting and ending height, and corresponding positions in the chart. The heights may be based on a percentage of the total value of data that is included within a particular category. The system then calculates positions of the various bars on the chart based on information provided by the user, or automatically based on the analysis of the data corresponding to the different categories. One or more curves are then calculated for each of the different categories to illustrate the transition of the data from a starting point to an ending point on the chart.

### BACKGROUND

One or more implementations relate to the field of graphical charting and display of information, and more specifically to modified and improved Sankey charting methods.

Sankey charting is used in certain situations in order to show the movement of data. Sankey charts are a type of flow diagram used to show flow of data. Sankey charts are often depicted with multiple different bars, each depicting the flow of data from one state to another. The bars are illustrated with a given height meant to represent an amount. In traditional Sankey charts, the height of these bars are determined in advanced and remain constant.

### BRIEF DESCRIPTION OF THE DRAWINGS

The accompanying drawings are incorporated herein and form a part of the specification.

FIG. 1 illustrates an exemplary Sankey chart, according to some embodiments.

FIG. 2 illustrates an exemplary variable Sankey chart, according to some embodiments.

FIG. 3 illustrates a block diagram of an exemplary variable Sankey charting environment, according to some embodiments.

FIG. 4 illustrates a block diagram of an exemplary Sankey charting system according to some embodiments.

FIG. 5 illustrates a flowchart diagram of an exemplary variable Sankey charting method, according to embodiments of the present disclosure.

FIG. 6 illustrates a flowchart diagram of an exemplary method for variable Sankey charting according to embodiments of the present disclosure.

FIG. 7 illustrates a block diagram of an exemplary computer system for implementing one or more aspects of the disclosed embodiments according to various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for variable Sankey charting.

Sankey charting is used in certain situations in order to show the movement of data. Sankey charts are a type of flow diagram used to show flow of data. Sankey charts are often depicted with multiple different bars, each depicting the flow of data from one state to another. The bars are illustrated with a given height meant to represent an amount. However, in traditional Sankey charts, the height of these bars are determined in advanced and remain constant.

Specifically, Sankey is designed to show the movement of data, not the growth or reduction of that data. This significantly hampers its usefulness in certain scenarios. Such an example may include the tracking of stock investments. In that scenario, money does not simply move from one location to another, but additionally changes over time. Tracking sales data of a sales team is another example. In that scenario, certain amounts may be identified at a starting date as being likely sales. However, throughout the course of the sales efforts some of those sales may fall through while others may follow through to completion at higher or lower numbers than the original estimates. This results in a change in the amount of data that traditional Sankey charts do not show efficiently. Therefore, there is a need for a modified Sankey charting method and system that is capable of not only showing the flow of data, but also the change in amounts of that data.

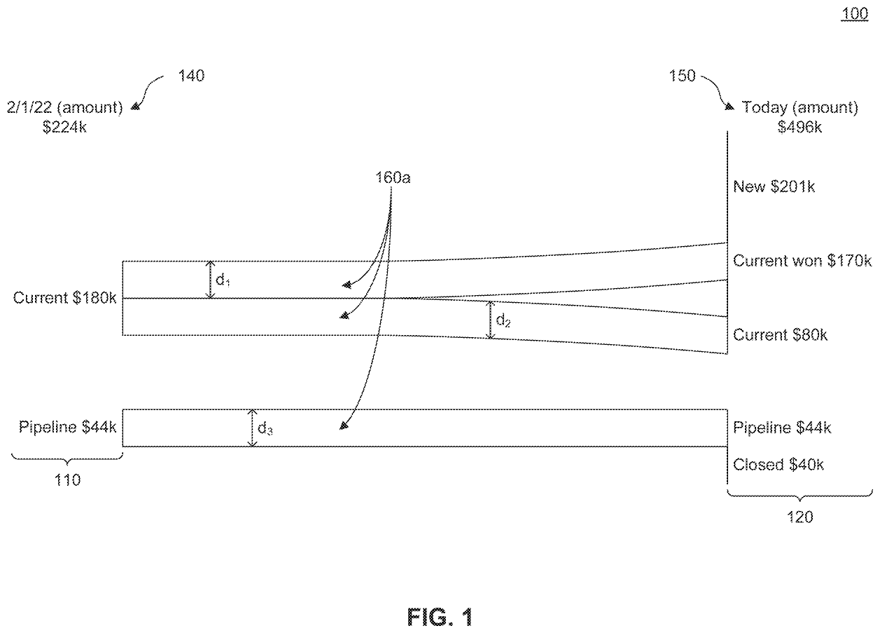

FIG. 1 illustrates an exemplary Sankey chart 100, according to some embodiments. As shown in FIG. 1, several categories 110 are defined on the left side of the chart, including a current category and a pipeline category. Each of the amounts associated with those categories 110 is an amount at a starting date 140. As shown in the chart 100, the starting total amount is $224 k, whereas the starting amount of the current category is $180 k, and the starting amount of the pipeline category is $44 k.

The right side of the chart 100 also includes several categories 120, many of which did not exist at the starting date 140. These categories 120 include New, Current Won, Current, Pipeline, and Closed. Additionally, the categories 120 show the categories and amounts at a second date (e.g., a current date) 150. A plurality of bars 160 show the flow of money from the left side of the chart to the right side of the chart. Each bar 160 has a corresponding height d indicative of an amount of the starting funds have moved to the new category.

In the embodiment of FIG. 1, the changing of the values from the start 140 to the end 150 has been shoehorned into standard Sankey charting. Hence, two bars are shown leaving the current category on the left side of the graph in order to show that some of that has become new category Current Won on the right side, whereas other of that money has remained Current. Similarly, new categories on the right (e.g., New and Closed) have no bar connected to them from the left side indicating money that did not exist at the starting date 140. Although this accurately conveys the data, this depiction is not effective, as it can be confusing as to where the different funds originate and how those funds change from one side of the chart to the other. As discussed above, this is a direct result of the strictures associated with Sankey charting, and the requirement that bars be kept at a constant height. Thus, even though the Sankey chart is somewhat useful, it is not truly effective in its current form as the reader would need to extrapolate information.

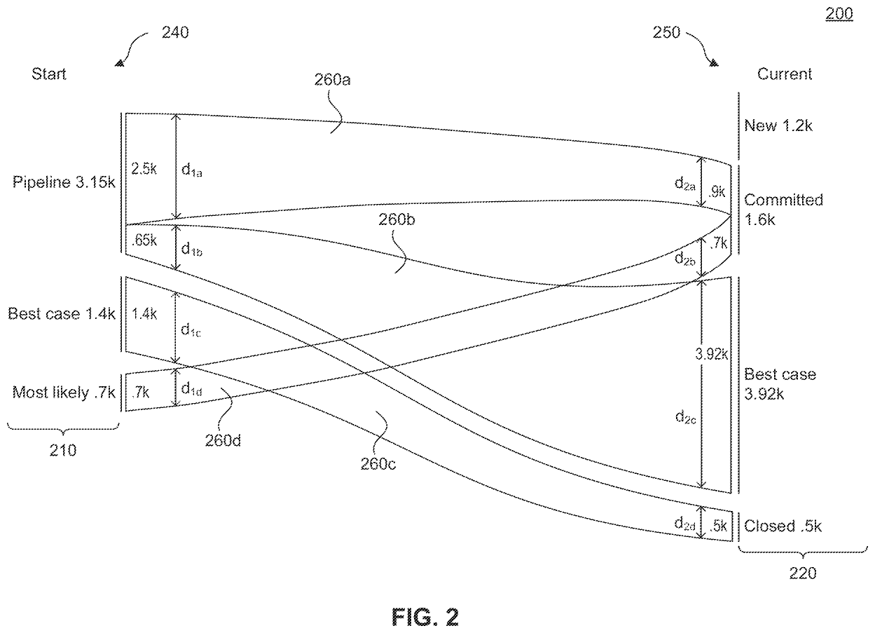

FIG. 2 illustrates an exemplary variable Sankey chart 200, according to some embodiments. As shown in FIG. 2, the chart 200 has a similar basic setup to that of chart 100, in that several starting categories 210 and ending categories 220 are shown, the starting categories being associated with a start date 240, and the ending categories being associated with a current or end date 250. Additionally, the categories 210 may overlap with, be the same as, or may be different from the categories on the right. Additionally, there are several bars 260 that connect the left side categories 210 to the right side categories 220 in order to show the movement of the data from the starting date 240 to the ending date 250. However, as shown in FIG. 2, rather than the bars having a fixed height, the bars have variable height to show the change in the amounts from the left side to the right side.

For example, bar 260a connects the pipeline category on the left to the Committed category on the right. At the left side of the chart 200, the bar 260a has a starting height d₁ₐ, whereas bar 260a has a height d₂ₐ on the right. This change in height d of the bar 260 shows clearly that the amount of the funds within that bar decreased from the start 240 to the current 250. In the example of FIG. 2, this is confirmed by the starting value being $2.5 k, and the ending value being $0.9 k.

The other bars have similar configurations. For example, bar 260b has an initial height of d_{1b} and an ending height of d_{2b}, bar 260c has an initial height of d_{1c} and an ending height of d_{2c}, and bar 260d has an initial height of d_{1d} and an ending height of d_{2d}. As described above, each of these height changes visually represents a change in the amount of data. When combined in the manner depicted in FIG. 2 with the bars, the Sankey chart is capable of not only showing the movement of the data over time, but also the change in the amount of that data. With this configuration, the usefulness of the Sankey chart is significantly expanded, as the consumer of the information provided by the Sankey chart can fully appreciate all the data and its movement over time visually, without having to decipher or extrapolate anything in a non-visual way.

Although not specifically shown, it should be understood that starting and ending values may be positive numbers (above zero), negative numbers (below zero), or zero. For example, although bar 260c may begin on the left side of the chart as a positive value range (above zero), its ending range on the right side of the chart may be a negative value range (below zero).

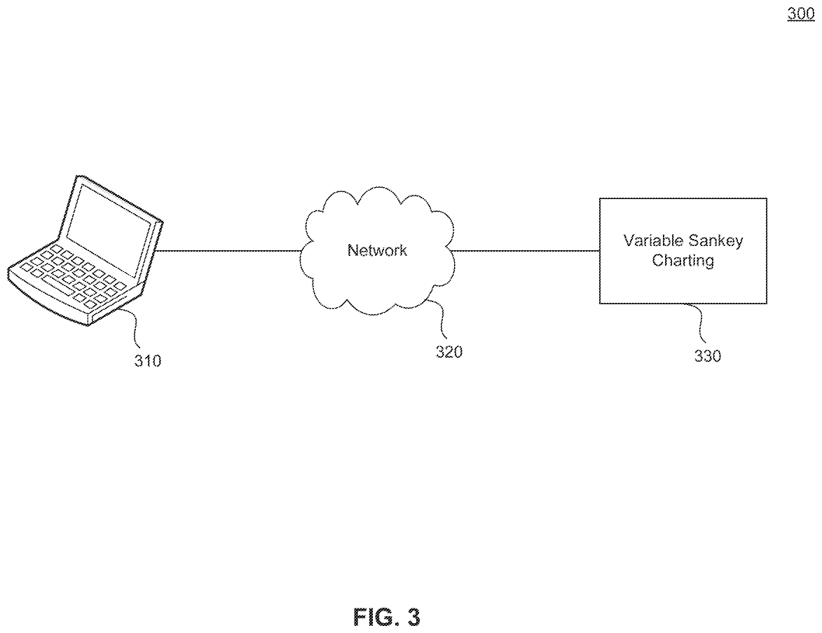

FIG. 3 illustrates a block diagram of an exemplary variable Sankey charting environment 300, according to some embodiments. As shown in FIG. 3, the environment 300 includes a workstation 310 connected to the variable Sankey charting system 330 via a network 320.

In embodiments, workstation 310 may be any suitable electronic device capable of communicating over the Network 320, including a personal computer, a cellular smartphone, or other electronic communication device. In embodiments, the workstation 310 includes a user interface and a user input device in order to allow a user to enter and/or submit data to the variable Sankey charting system 330. In embodiments, the user enters parameters, provides links to data lists or database, enters customization options, and other information into the workstation 310. The workstation 310 transmits, via a transceiver of the workstation 310, the entered information to the network 320.

Network 320 may be any suitable communication network capable of carrying the electronic signals from the workstation 310 to the variable Sankey charting system 330. The network 320 may be a wired network, a wireless network, or a hybrid network. In embodiments, the network may include one or more of a Personal Area Network (PAN), Local Area Network (LAN), Wide Area Network (WAN), public switched telephone network (PSTN), etc.

The variable Sankey charting system 330 receives the charting request that includes the various user inputs, including the parameters, data identifiers, customization options, etc., and uses this information to generate the variable Sankey chart, such as depicted for example in FIG. 2. The variable Sankey charting system 330 and its functionality will be described in further detail below with respect to the additional figures.

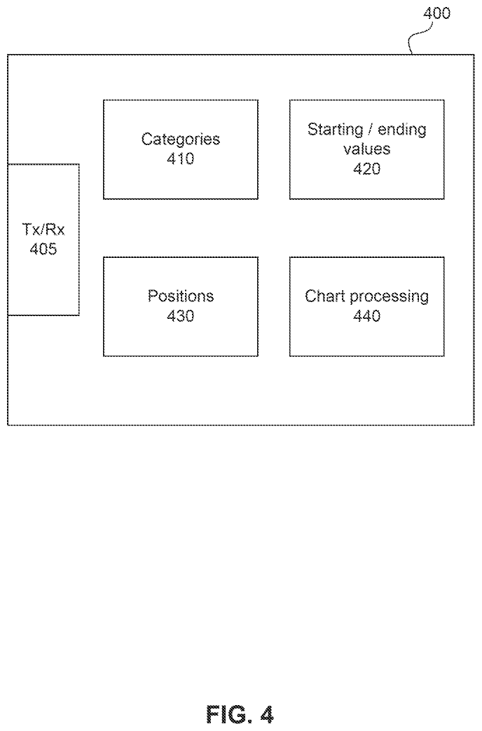

FIG. 4 illustrates a block diagram of an exemplary Sankey charting system 400 according to some embodiments. As shown in FIG. 4, the variable Sankey charting system 400 includes a transceiver 405, a categories block 410, a starting/ending values block 420, a positions block 430, and a chart processing block 440, and may represent an embodiment of the variable Sankey charting system 330 of FIG. 3. In embodiments, each of the different blocks 410-440 includes one or more processors for carrying out the functions associated with the respective blocks. In another embodiment, one or more central processors carries out the functions of the various blocks.

The system 400 receives the charting request from the workstation 310 via transceiver 405. The transceiver 405 includes a communication interface capable of communicating with the network, thereby exchanging electronic messages with the network. When a request is sent to the system 400, the request is received at the transceiver 405 from the network 320. In various embodiments, the transceiver 405 performs various front-end processes on the received message in order to interpret the data therein. Such request is demodulated, decoded, error-corrected, etc. The transceiver 405 then forwards the message to the various blocks for processing.

Categories block 410 performs category identification. These include the starting and ending categories for charting (e.g, Pipeline, best case, most likely, committed, closed, new in FIG. 2). In an embodiment, the categories may be defined by the user in the request in one or more fields. Such categories may indicate one or more columns of data in a database, entries in a database, lists of data, etc. In other embodiments, the categories block 410 identifies the categories from the data provided. In such an embodiment, categories block 410 may infer the starting and ending categories from the data provided. For example, when the data provided to the system 400 includes starting data that is labeled, binned, or categorized under different groups. Based on this information, the categories block extracts or otherwise identifies the different categories for charting.

Values block 420 then identifies the starting and ending values for each of the different categories. This information may be provided by the user in the request, or extracted from the data. For example, once the categories of data are known, the starting and ending values of the different categories can be determined from the dataset provided by the user. In one embodiment, the values block 420 accesses the data set, which may be organized with different entries being associated with different dates, or may be organized according to date with different entries being associated with different categories. In either situation, the data will have indicators that allow the values block to identify the starting and ending values for the different categories. Additionally, these starting and ending values may also include data transitions—the amount of change data that became recategorized from each of the starting categories to each of the ending categories. In embodiments, provided that the system is made aware of a normal progression of data, these recategorizations can be calculated by the system automatically.

Positions block 430 is configured to determine the heights and positions of the various bars. According to an embodiment, the position block 430 receives the starting and ending categories from the categories block 410 and receives the category values from the values block 420. Initially, the positions block 430 determines a number of starting categories and a number of ending categories. Then, for the starting edge of the graph, the positions block 430 determines a percentage of the total amount of starting data is associated with each category. For example, in the sales example provided above, the pipeline starting category accounts for 60% of the total starting funds, the “best case” category accounts for 27% of the starting funds, and the “most likely” category accounts for 13% of the total starting funds. Based on this information, the positions block 430 sizes the first bar (starting at the pipeline category) to be approximately 60% of the total height of the chart. Similarly, the positions block 430 sizes the second and their bars to be 27% and 13% of the total height of the chart, corresponding to the “best case” and “most likely” categories, respectively. The positions block 430 performs a similar operation for the ending categories and corresponding ending values, determining percentages of a total amount, and calculating the sizes of the different bars at the right side of the chart consistent with those percentages.

The positions block 430 then determines the positions of the different bars/categories. In an embodiment, the general positions may be provided by the user in the request. For example, the request may indicate which category should be illustrated at the top of the chart, at the bottom, and at the positions in between. Alternatively, the positions block 430 can perform automatic positioning according to one or more rulesets, such as by placing the largest category at the top, etc.

Once the positions have been determined, upper and lower starting points of each of the bars is calculated by the positions block 430. In particular, each bar has a starting edge along the left side of the chart that defines the starting height of the bar. As discussed above, in an embodiment, this starting height is indicative of a relative percentage of the total amount of starting value. Therefore, once the positions block 430 determines the overall percentage of an individual bar and its location relative to the other bars, the positions block can then determines the starting and ending locations of the left edge of the bar. For example, a first bar may begin at the bottom of the graph, and therefore its left edge has a lower starting position of y=0. If an overall available height is 100, and the first bar accounts for 60% of the starting funds, then the upper position of the left edge would be positioned at y=60.

In embodiments, the positions bar can account for spaces between different bars. For example, in an embodiment, the individual bars are spaced apart by 5 points of the available height. In the above example having 3 separate bars, this reduces the available height to 85 points. Thus, the upper position of the first bar would be 60% of 85=51. The starting point of the next bar would begin at point 56 (accounting for the 5-point spacing), and its upper height would be positioned a percentage of points above the starting point based on its percentage (e.g., 85*27%+56=79). This is repeated for each additional bar.

A chart processing block 440 then generates the chart. The chart processing block receives the categories from block 410, starting and ending values from block 420, and the starting and ending positions and heights from block 430. Using this information, the chart processing block 440 generates the visual representation of the data, shown for example in FIG. 2. At a minimum, the chart processing block 440 generates the chart to illustrate the different bars with varying height as they move from their starting categories to their respective ending categories. Depending on preconfigured settings or those provided by the user, the chart processing block 440 can include several additional details, such as labeling start and ending values, labeling the different categories, labeling the start and end (including beginning and ending dates), etc.

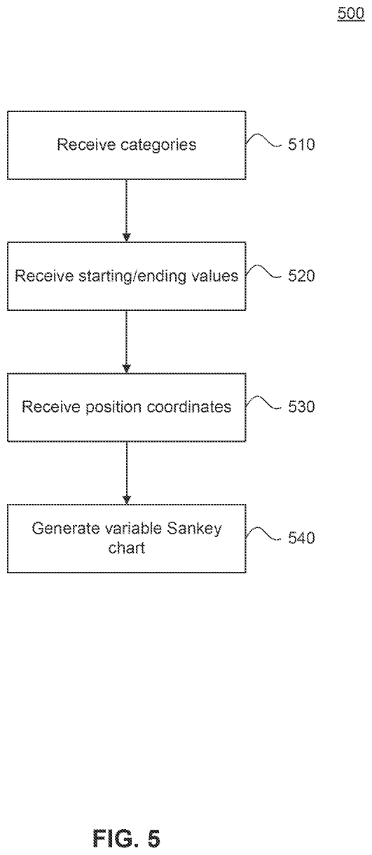

FIG. 5 illustrates a flowchart diagram of an exemplary variable Sankey charting method 500, according to embodiments of the present disclosure.

As shown in FIG. 5, the method 500 begins at step 510, where the system receives categories. As discussed above, the categories can be received from the user in the request, or can be automatically identified. Such categories may indicate one or more columns of data in a database, entries in a database, lists of data, etc. In other embodiments, the categories block 410 identifies the categories from the data provided.

In step 520, the system receives starting and ending values for each of the different categories of data. Here again, this data may be provided by the user or can be extracted from the available data. Additionally, the system receives the recategorizations of the different data from their respective starting categories to their respective ending categories.

In step 530, position coordinates are received. As discussed above, the position coordinates are provided or determines for each edge of each starting and ending bar. In some embodiments, this information is calculated based on the starting and ending values associated with the different categories. In some embodiments, these values also account for spacing between different bars and/or groups of bars.

In step 540, once the above information has all been obtained, the variable height Sankey chart can be generated. Specifically, each of bars are illustrated with the left and right edges at the established positions, and are then connected to each other with curvatures defined by one or more graphing equations. Additional labels can be added to the graph to assist with understanding, such as starting and ending values, category labels, and start and end dates or other indicators.

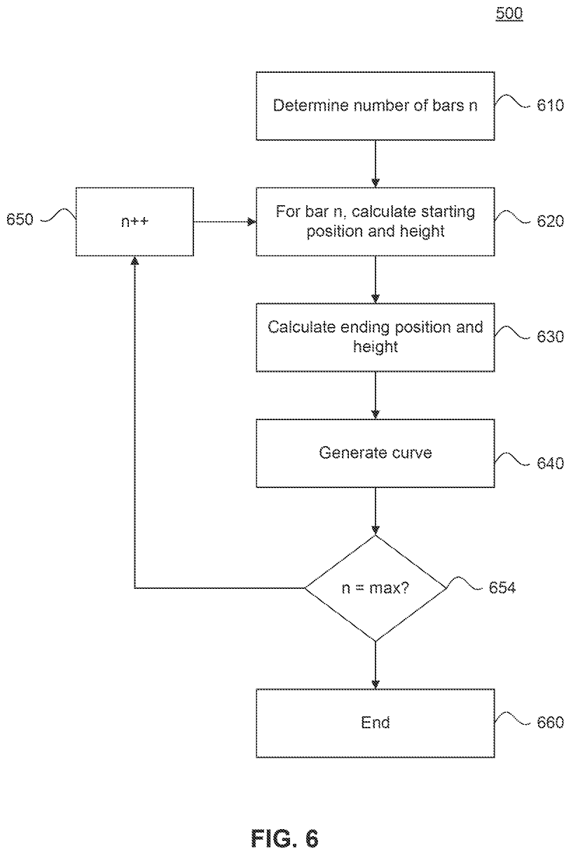

FIG. 6 illustrates a flowchart diagram of an exemplary method 600 for variable Sankey charting according to embodiments of the present disclosure. As shown in FIG. 6, the method begins at step 610 by determining a number of bars n. In an embodiment, the number of bars is equivalent to the number of categories, and may differ between the starting (left) and ending (right) sides of the chart. In other words, n may be different depending on the start or end of the chart. However, for purposes of this example, n is constant from the beginning of the chart to the end of the chart.

In step 620, beginning with a first bar (e.g., n=1), a starting position and height is calculated. Specifically, as discussed above, the left side of each bar has a height corresponding to a relative percentage of the total amount of data that is included with its category. Additionally, the position of the bar is based on its vertical position relative to the other bars. For example, in an embodiment, a bottom starting position of a first bar starts at a vertical position 0, a top of that bar having an ending height based on the calculated height. In an embodiment, a bottom starting position of a second bar begins at that same location. In other embodiments, there is a spacing between the bars that is also accounted for, as described above.

In step 630, a similar calculation is performed for the ending (e.g., right side) edges of the corresponding bars.

In step 640, the curvature for each of the different bars is calculated. In an embodiment, the curvature is calculated based on one or more mathematical formals, such as a best-fit curve using one or more of a polynomial, sine/cosine wave, or other suitable function. In an embodiment, each bar include two curves, one to connect the top points of the left and right edges of the bar, and a second curve to connect the bottom points of the left and right edges of the bar.

In step 645, a determination is made as to whether the curves have been completed for all the different bars (e.g., whether n=max). If not, then n is incremented in step 650, and steps 620-645 are repeated for the current bar. If all bars have been calculated (e.g., 645—Yes), then the method ends in step 660.

It will be understood that the order of the above steps are merely exemplary, and the steps can be rearranged in any appropriate manner. For example, in embodiments, the envoy may perform local rate limiting prior to mapping the header and conducting a global rate limiting check. Additionally, more or fewer steps may be included in the exemplary method consistent with the disclosure.

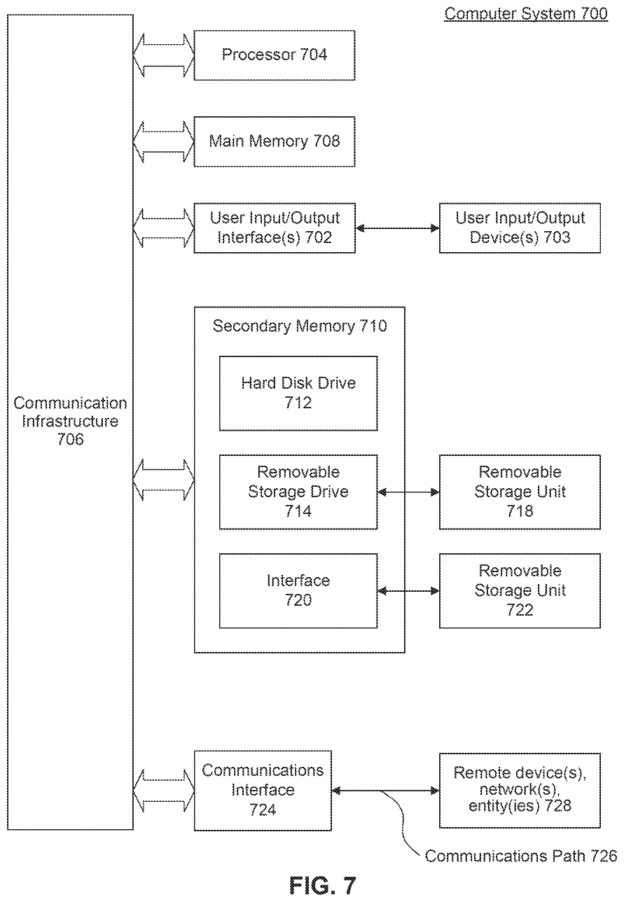

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include customer input/output device(s) 703, such as monitors, keyboards, pointing devices, etc., which may communicate with communication infrastructure 706 through customer input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random-access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system for variable height Sankey charting, comprising:
a transceiver configured to receive a charting request from a user, the charting request including a reference to a dataset to be charted; and
one or more processors configured to:
identify, based on an analysis of the dataset, a starting point, an ending point, and a plurality of categories of data;
determine, from the dataset, a starting total amount of value existing at the starting point and an ending total amount of value existing at the ending point;
calculate starting and ending value amounts for each of the plurality of categories;
generate a chart that includes a plurality of bars corresponding, each corresponding to one of the plurality of categories illustrating a transition of the data included within the dataset from the starting point to the ending point; and
outputting or displaying the generated chart to the user.

2. The system of claim 1, wherein the plurality of categories includes a plurality of starting categories existing at the starting point and a plurality of ending categories existing at the ending point.

3. The system of claim 1, wherein the one or more processors are further configured to calculate a starting height and an ending height for each of the plurality of bars.

4. The system of claim 3, wherein the starting height is calculated based on a percentage value of a total value associated with the corresponding category at the starting point, and
wherein the ending height is calculated based on a percentage value of a total value associated with the corresponding category at the ending point.

5. The system of claim 1, wherein the one or more processors are further configured to:
calculate an upper vertical position and a lower vertical position for each of the plurality of bars at the starting point; and
calculate an upper vertical position and a lower vertical position for each of the plurality of bars at the ending point.

6. The system of claim 5, wherein the lower vertical position of a subsequent one of the plurality of bars is equal to an upper vertical position of a previous one of the plurality of bars.

7. The system of claim 5, wherein the one or more processors are further configured to:
calculate an upper curve for a first one of the plurality of bars that connects its upper vertical position at the starting point to its upper vertical position at the ending point using one or more mathematical functions; and
calculate a lower curve for the first one of the plurality of bars that connects its lower vertical position at the starting point to its lower vertical position at the ending point using the one or more mathematical functions,
wherein the combined upper and lower curve illustrate the change in amount of data included in a first category corresponding to the first one of the plurality of bars from the starting point to the ending point.

8. A method for generating a variable height Sankey chart, comprising:
receiving a charting request from a user, the charting request including a reference to a dataset to be charted;
identifying, based on an analysis of the dataset, a starting point, an ending point, and a plurality of categories of data;
determining, from the dataset, a starting total amount of value existing at the starting point and an ending total amount of value existing at the ending point;
calculating starting and ending value amounts for each of the plurality of categories;
generating a chart that includes a plurality of bars, each corresponding to one of the plurality of categories illustrating a transition of the data included within the dataset from the starting point to the ending point; and
outputting or displaying the generated chart to the user.

9. The method of claim 8, wherein the plurality of categories includes a plurality of starting categories existing at the starting point and a plurality of ending categories existing at the ending point.

10. The method of claim 8, further comprising calculating a starting height and an ending height for each of the plurality of bars.

11. The method of claim 10, wherein the starting height is calculated based on a percentage value of a total value associated with the corresponding category at the starting point, and
wherein the ending height is calculated based on a percentage value of a total value associated with the corresponding category at the ending point.

12. The method of claim 8, further comprising:
calculating an upper vertical position and a lower vertical position for each of the plurality of bars at the starting point; and
calculating an upper vertical position and a lower vertical position for each of the plurality of bars at the ending point.

13. The method of claim 12, wherein the lower vertical position of a subsequent one of the plurality of bars is equal to an upper vertical position of a previous one of the plurality of bars.

14. The method of claim 12, further comprising:
calculating an upper curve for a first one of the plurality of bars that connects its upper vertical position at the starting point to its upper vertical position at the ending point using one or more mathematical functions; and
calculating a lower curve for the first one of the plurality of bars that connects its lower vertical position at the starting point to its lower vertical position at the ending point using the one or more mathematical functions,
wherein the combined upper and lower curve illustrate the change in amount of data included in a first category corresponding to the first one of the plurality of bars from the starting point to the ending point.
generating, by the one or more computing devices, a chart that includes a plurality of bars corresponding to respective ones of the plurality of categories that illustrates a transition of the data included within the dataset from the starting point to the ending point; and

15. A method for generating a variable height Sankey chart, comprising:
receiving a charting request from a user, the charting request including a plurality of charting parameters and an identification of a dataset to be charted;
accessing or retrieving the dataset;
identifying, based on an analysis of the dataset to be charted responsive to the charting request, a starting point, an ending point, and a plurality of categories of data in the dataset;
determining, by one of more computing devices, a starting total amount of value existing at the starting point and an ending total amount of value existing at the ending point;
calculating, by the one or more computing devices, starting and ending value amounts for plurality of categories;
generating, by the one or more computing devices, a chart that includes a plurality of bars corresponding to respective ones of the plurality of categories that illustrates a transition of the data included within the dataset from the starting point to the ending point; and
presenting, by the one or more computing devices, the generated chart.

16. The method of claim 15, wherein the plurality of charting parameters includes an identification of the plurality of different categories and vertical positions of the each of the plurality of different categories at a starting point of the chart and an ending point of the chart.

17. The method of claim 16, wherein the plurality of categories includes a plurality of starting categories that exist at the starting point, and a plurality of ending categories that exist at the ending point.

18. The method of claim 15, further comprising calculating one or more curves corresponding to the plurality of bars, wherein the one or more curves includes an upper curve that connects a topmost point of the starting points to a corresponding topmost point of the ending points.

19. The method of claim 15, wherein the plurality of charting parameters includes an order of the plurality of categories.

20. The method of claim 19, further comprising:
calculating a vertical starting position for each of the plurality of bars, the calculating including:
setting a vertical starting position of a first bar according to the order at a bottommost position;
calculating a height of the first bar based on a percentage of the overall data included in the first bar;
setting a vertical ending position of the first bar based on the calculated height; and
setting a vertical starting position of a second bar based on the vertical ending position of the first bar.
